(19) United States
(12) Patent Application Publication
(10) Pub. No.: US 2004/0084099 A1
(43) Pub. Date: May 6, 2004

(54) Sealing plug

(75) Inventor: Hideya Miura, Toyoake-shi (JP)

Correspondence Address: KANESAKA AND TAKEUCHI, Suite 2, 1423 Powhatan Street, Alexandria, VA, 22314, US

(73) Assignee: NIFCO INC.

(21) Appl. No.: 10/633,632

(22) Filed: Aug. 5, 2003

(30) Foreign Application Priority Data
Nov. 5, 2002 (JP) 2002-321056

(51) Int. Cl. F16L 55/10

(52) U.S. Cl. 138/89; 138/92

(57) ABSTRACT

A sealing plug seals a hole portion formed in a panel. The sealing plug includes a flange portion for contacting a peripheral edge of the hole portion, a cylindrical body connected to the flange portion, a straight portion formed on an outer peripheral surface of the cylindrical body along an axis line thereof, and a step portion projecting from the outer peripheral surface of the cylindrical body at a side opposite to the straight portion. The step portion abuts against the peripheral edge of the hole portion when the straight portion passes through the hole portion to allow the cylindrical body to incline with respect to a center line, and holds the peripheral edge of the hole portion together with the flange portion. A neck portion having a diameter substantially the same as an inner diameter of the hole portion is formed between the step portion and the flange portion.

### BACKGROUND OF THE INVENTION AND RELATED ART STATEMENT

The invention relates to a sealing plug for sealing a drain hole and the like provided in a body panel of a vehicle.

A sealing plug for sealing a circular hole portion, such as a drain hole, provided in a body panel of a vehicle has been disclosed, for example, in Japanese Utility Model Publication (KOKOKU) No. 62-29400. The sealing plug has a flange portion provided at one end of a cylindrical body constituting the sealing plug. A space corresponding to a wall thickness of the body panel is provided between the flange portion and the cylindrical body at the flange portion side, thereby forming an annular claw portion.

An annular groove portion formed of the flange portion and the claw portion has an outer diameter substantially same as an inner diameter of the hole portion. The sealing plug engages the hole portion in a state that the flange portion and the claw portion hold a peripheral edge of the hole portion, thereby sealing the hole portion.

In a plan view, a substantially cylindrical hollow pressing surface portion projects at the center of the flange portion, and a top end surface thereof is inclined downwardly from a level the same height as that of the flange portion.

An end portion of the cylindrical body has an outer diameter slightly smaller than the inner diameter of the hole portion, and the outer diameter gradually becomes larger toward the flange portion so as to be slightly larger than the inner diameter of the hole portion.

The sealing plug is inserted in the hole portion in a state that a space is formed between the body panel and the flange portion. In this state, the body panel and the flange portion are substantially parallel to each other. When a higher height portion of the pressing surface portion is pressed, the claw portion at the pressed side passes through the hole portion, and the flange portion is inclined with respect to the body panel. As a result, a space is formed between the body panel and the flange portion at a lower height portion of the pressing surface portion.

When the lower height portion of the pressing surface portion of the flange portion is pressed, the claw portion above the hole portion passes through the hole portion so that the flange portion makes a surface contact with the body panel. Accordingly, the flange portion and the claw portion sandwich the peripheral edge of the hole portion to seal the hole portion.

However, in the conventional sealing plug described above, it is necessary to press the sealing plug twice to seal the hole portion, thereby requiring an extra work. Also, the claw portion is continuously formed around the entire periphery of the cylindrical body. Therefore, it is necessary to deform the cylindrical body to reduce the diameter thereof when the claw portion with the diameter larger than the inner diameter of the hole portion passes through the hole portion with one pressing, thereby requiring a large force and resulting in poor workability.

In view of the above defects, it is an object of the present invention to provide a sealing plug capable of being attached to a hole portion with a small force.

Further objects and advantages of the invention will be apparent from the following description of the invention.

### SUMMARY OF THE INVENTION

According to the first aspect of the invention, a sealing plug for sealing a hole portion formed in a body panel of a vehicle comprises: a flange portion for making a surface contact with a peripheral edge of the hole portion; a cylindrical body connected to the flange portion for inserting into the hole portion; a straight portion formed on an outer peripheral surface of the cylindrical body along an axis line thereof; a step portion projecting from the outer peripheral surface of the cylindrical body at a side opposite to the straight portion for abutting against the peripheral edge of the hole portion, and for holding the peripheral edge of the hole portion together with the flange portion when an end portion of the straight portion passes through the hole portion to allow the cylindrical body to incline with respect to a center line of the hole; and a neck portion formed between the step portion and the flange portion and having a diameter substantially the same as an inner diameter of the hole portion.

In the first aspect of the invention, the straight portion is formed on the outer peripheral surface of the cylindrical body along the axis line of the cylindrical body, and the step portion is formed at the side opposite to the straight portion. The step portion abuts against the peripheral edge of the hole portion when the end portion of the straight portion is inserted in the hole portion to thereby incline the cylindrical body with respect to the center line of the hole portion.

As described above, the cylindrical body is tilted with respect to the center line of the hole portion. As a result, when pressing just the flange portion at the side where the step portion is provided, the step portion passes through the hole portion and the neck portion faces an inner peripheral surface of the hole portion. In this state, the body panel is held between the flange portion and the step portion, and the sealing plug is attached and closes the hole portion. As described above, by only pressing the flange portion once, the sealing plug can be attached to the hole portion, so that it is easy to attach the sealing plug to the hole portion and the workability is improved.

According to the second aspect of the invention, a lower surface of the step portion is inclined with respect to a surface perpendicular to an axis line of the cylindrical body. While the lower surface of the step portion abuts against the peripheral edge of the hole portion, as the lower surface of the step portion is inclined with respect to the surface perpendicular to the axis line of the cylindrical body, the cylindrical body is tilted with respect to the center line of the hole portion.

According to the third aspect of the invention, a plurality of step portions is formed with a predetermined space therebetween in a peripheral direction of the cylindrical body. The step portions are formed intermittently in the peripheral direction of the cylindrical body. As a result, it is possible to reduce a pressing force when the cylindrical body passes through the hole portion as opposed to a case where the step portion is continuously formed. Thus, the sealing plug can be easily attached to the hole portion with a small force.

According to the fourth aspect of the invention, a depression is formed at the center portion of the flange portion, and a boss is provided at the center of the depression. When the flange is pressed, the step portion passes through the hole portion. It is possible to place a finger on the flange portion and the boss at the central portion of the flange portion. Therefore, the flange portion can be easily pressed. Also, since the area where the finger is placed is increased, the pressing force per unit area is reduced.

### BRIEF DESCRIPTIONN OF THE DRAWINGS

FIG. 1 is a perspective view of a sealing plug according to an embodiment of the invention;

FIG. 2 is a plan view of the sealing plug;

FIGS. 3(A)-3(C) are views showing the sealing plug, wherein FIG. 3(A) is a left side view of the sealing plug, FIG. 3(B) is a front view of the sealing plug, and FIG. 3(C) is a right side view of the sealing plug;

FIG. 4 is a bottom view of the sealing plug;

FIG. 5 is a sectional view taken along line 5-5 in FIG. 2; and

FIGS. 6(A) and 6(B) are views showing the sealing plug, wherein FIG. 6(A) shows a state that an end portion with a straight portion of the sealing plug is passed through a hole portion, and FIG. 6(B) shows a state that the sealing plug is attached to the hole portion.

### DETAILED DESCRIPTION OF PREFERRED EMBODIMENTS

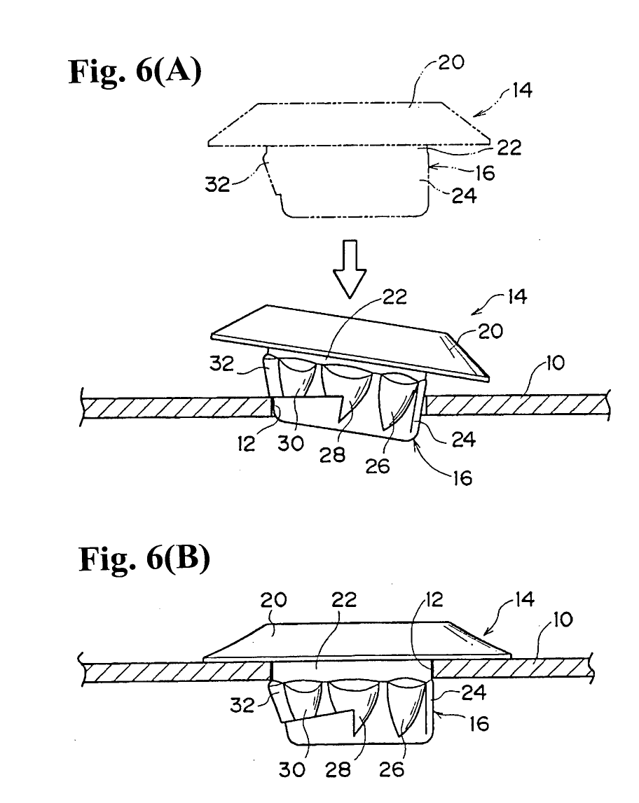

Hereunder, embodiments of the invention will be explained with reference to the accompanying drawings. As shown in FIGS. 6(A) and 6(B), a circular hole portion 12, such as a drain hole, is formed in a body panel 10 of an automobile, and the hole portion 12 is closed by a sealing plug 14. The sealing plug 14 includes a cylindrical body 16. An outer periphery of the cylindrical body 16 has a smaller diameter than an inner diameter of the hole portion 12 so that the cylindrical body 16 can be inserted into the hole portion 12.

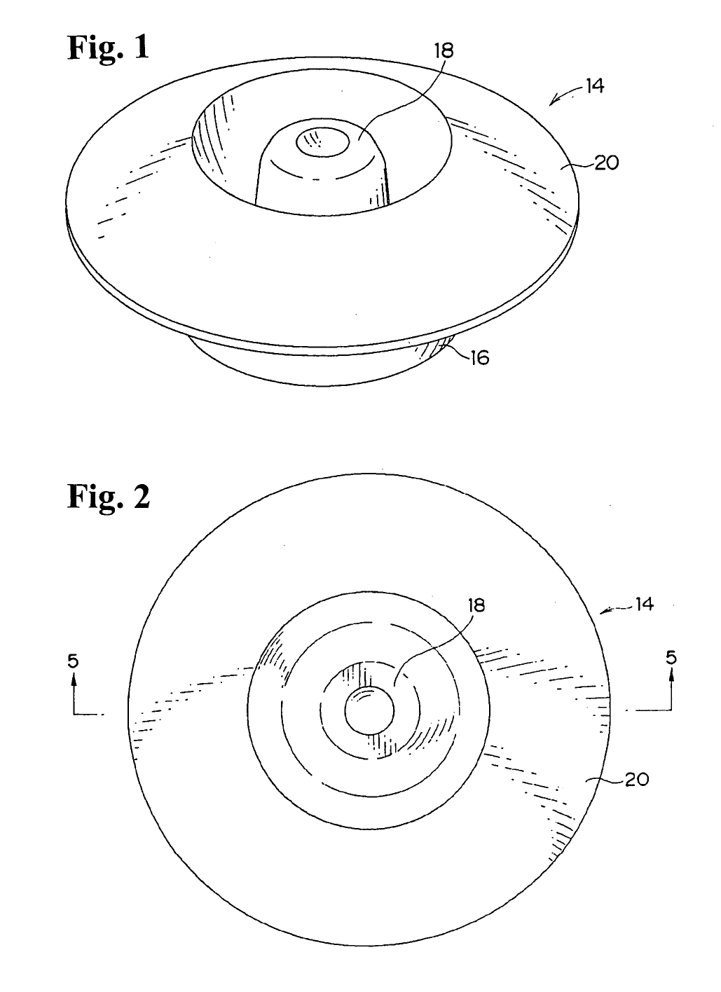

As shown in FIGS. 1, 2 and 5, one end of the cylindrical body 16 is provided with a bottom portion 16A, and a boss 18 extends from the center of a back surface of the bottom portion 16A to a height of the other end of the cylindrical body 16. Accordingly, the boss 18 has a hollow body, and a space is formed between an outer peripheral surface of the boss 18 and an inner peripheral surface of the cylindrical body 16.

As shown in FIGS. 5 and 6(B), a thin annular flange portion 20 extends downwardly from the other end portion of the cylindrical body 16. When the sealing plug 14 is attached to the hole portion 12, a forward end of the flange portion 20 makes a surface contact with a peripheral edge of the hole portion 12.

An outer peripheral surface of the cylindrical body 16 at a side of the flange portion 20 is formed in an annular neck portion 22. The neck portion 22 has substantially the same diameter as an inner diameter of the hole portion 12 so that the neck portion 22 faces the inner peripheral surface of the hole portion 12 in a state that the sealing plug 14 is inserted into the hole portion 12. A straight or parallel portion 24 is formed on a part of the outer peripheral surface of the cylindrical body 16 under the neck portion 22, and projects along an axis line of the cylindrical body 16.

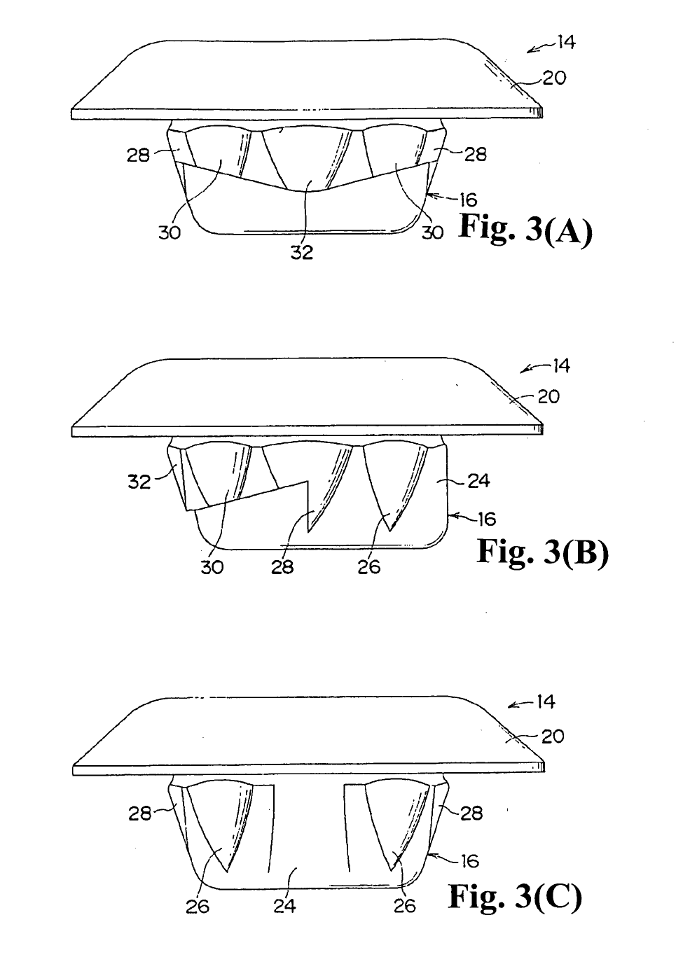

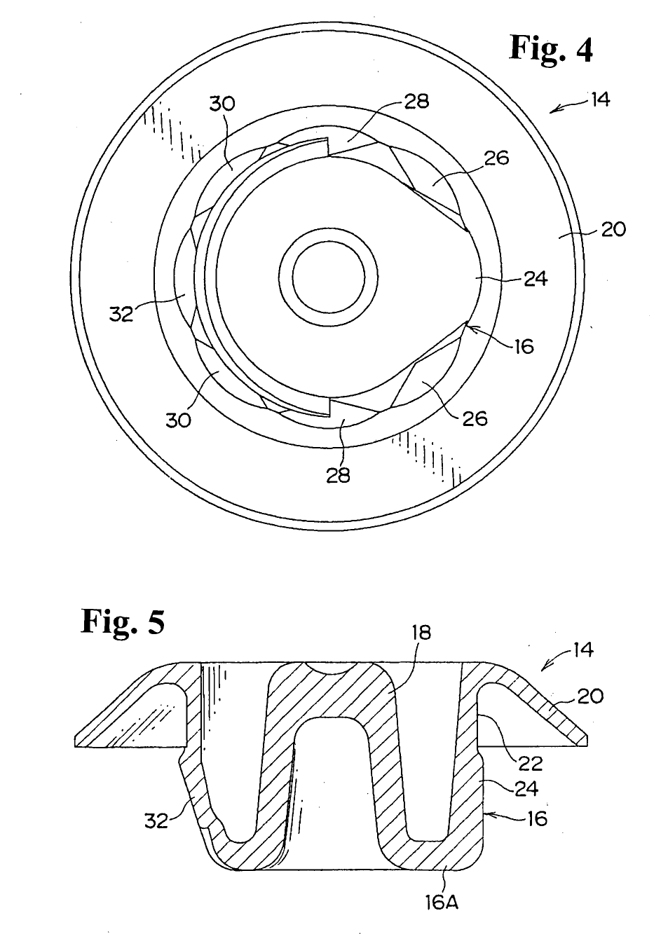

A plurality of step portions 26, 28, 30, 32 is disposed on both sides of the straight portion 24 below the neck portion 22 with a predetermined space therebetween, as shown in FIGS. 3(A)-3(C) and FIG. 4. FIG. 3(A) is a left side view of FIG. 3(B), and FIG. 3(C) is a right side view of FIG. 3(B).

The step portions 26, 28, 30, 32 are formed in a circular arc shape, and project along the peripheral direction of the cylindrical body 16. The step portions become narrower downwardly, and have a height from the outer peripheral surface of the cylindrical body 16 gradually decreasing downwardly. The step portions 26, 28, 30, 32 hold the peripheral edge of the hole portion 12 together with the flange portion 20.

Also, the step portion 32 is positioned at a side opposite to the straight portion 24. When the lower surfaces (in the case of the step portion 28, a part of the lower surface) of the step portions 28, 30, 32 are connected, the connected line is inclined with respect to a surface perpendicular to an axis line of the cylindrical body 16, and extends upward relative to the cylindrical body 16 from the step portion 32 to the straight portion 24.

The step 26 and a part of the step 28 at each side of the straight portion 24 are not on the connected line for connecting the lower surfaces of the step portions 28 (a part in 28), 30 and 32. The step 26 and the part of the step 28 are gradually narrowed toward the bottom portion 16A, and the forward end portions thereof are provided with tip portions.

A method of attaching the sealing plug according to the present embodiment will be explained next. As shown in FIG. 6(A), the outer peripheral surface of the cylindrical body 16 has a diameter smaller than the inner diameter of the hole portion 12, and the step portions 26, 28, 30, 32 project from the outer peripheral surface of the cylindrical body 16. When the sealing plug 14 is inserted into the hole portion 12 of the body panel 10, the end portion of the straight portion 24 is only inserted into the hole portion 12. The lower surfaces of the step portions (a part) 28, 30, 32 abut against the peripheral edge of the hole portion 12.

The lower surfaces of the step portions 28 (a part), 30, 32 are inclined with respect to the surface perpendicular to the axis line of the cylindrical body 16. Accordingly, the lower surfaces of the step portions (a part of) 28, 30, 32 abut against the peripheral edge of the hole portion 12 in a state that the end portion of the straight portion 24 is inserted into the hole portion 12, and the cylindrical body 16 is tilted with respect to the center line of the hole portion 12.

At this time, in order to insert the top end of the straight portion 24 into the hole portion 12, the step portions 26 and a part of 28 located on the straight portion 24 side are gradually narrowed from the upper portion to the bottom portion 16A side to form top portions, respectively. A step difference is not formed at a boundary between the outer peripheral surface of the cylindrical body 16 and the step portion 26 or 28, so that the straight portion 24 can be smoothly inserted into the hole portion 12.

Incidentally, in a state that the cylindrical body 16 is disposed in a tilted state with respect to the center line of the hole portion 12, the forward end side of the flange portion 20 on the straight portion 24 side abuts against the body panel 10. However, a space is formed between the flange portion 20 on the step 32 side and the body panel 10.

Next, the flange portion 20 on the step portion 32 side is pressed. At this time, since the boss 18 (refer to FIG. 5) is formed at the center portion of the flange portion 20, the top end surfaces of the flange portion 20 and boss 18 are pressed. Accordingly, the step portions 28(part), 30, 32 abutting against the peripheral edge of the hole portion 12 pass through the hole portion 12, as shown in FIG. 6(B), so that the neck portion 22 faces the inner peripheral surface of the hole portion 12 and the flange portion 20 extends outside over the entire periphery to face the body panel 10. In other words, the peripheral edge of the hole portion 12 is held by the flange portion 20 and the steps 26, 28, 30, 32 to thereby attach the sealing plug 14 to the hole portion 12.

An effect of the sealing plug according to the present embodiment will be explained next. As shown in FIGS. 3(A), 3(B), 3(C), the straight portion 24 is provided on the outer peripheral surface of the cylindrical body 16 along the axis line thereof. The step portions 28 (a part), 30, 32, having the inclined lower surfaces relative to the surface perpendicular to the axis line of the cylindrical body 16 are provided on the side opposite to the straight portion 24. As shown in FIG. 6(A), the cylindrical body 16 is disposed in the tilted state with respect to the center line of the hole portion 12, when the lower surface of the step portion 32 abuts against the peripheral edge of the hole portion 12 in a state that the end portion of the straight portion 24 passes through the hole portion 12.

Since the cylindrical body 16 is disposed in the tilted state with respect to the center line of the hole portion 12, when the flange portion 20 on the step portion 32 side is pressed, the entire peripheral edge of the hole portion 12 is held by the flange portion 20 and the step portion 32, thereby easily attaching the sealing plug 14 to the hole portion 12.

As described above, the sealing plug 14 of the invention is attached to the hole portion 12 with just one pressing. Therefore, it is easy to attach the sealing plug, thereby obtaining good workability.

The respective step portions 26, 28, 30, 32 are formed with a predetermined space therebetween. As a result, it is possible to pass the cylindrical body 16 through the hole portion 12 with a smaller force as opposed to a case that the respective step portions 26, 28, 30, 32 are continuously formed. Thus, the sealing plug 14 can be easily attached to the hole portion 12 with a smaller force.

Further, the boss 18 is provided at the center of the flange portion 20. Accordingly, it is possible to put a finger on the flange portion 20 and the boss 18, so that the flange portion 20 can be easily pressed. Also, the pressing force per unit area can be reduced due to a larger pressing area.

The space is provided between the cylindrical body 16 and the boss 18. Thus, the diameter of the cylindrical body 16 is easily shrunk. When the step portions 26, 28, 30, 32 pass through the hole portion 12, they can easily pass therethrough with a small force, thereby obtaining the good workability.

Further, the hole portion 12 is held by the respective step portions 26, 28, 30, 32 and the flange portion 20 after the step portions 26, 28, 30, 32 pass through the hole portion 12 in a state that the cylindrical body 16 is once shrunk. Thus, the attached sealing plug 14 is not easily detached from the hole portion 12.

Incidentally, in the present embodiment, the lower surfaces of the step portions are inclined with respect to the surface perpendicular to the axis line of the cylindrical body, and face the upper portion of the cylindrical body as they extend toward the straight portion from the step portions. However, the shape of the step portions is not limited to that of the present embodiment as far as the sealing plug is disposed in the tilted state with respect to the center line of the hole portion.

With the structure as described above, in the first aspect of the invention, it is possible to attach the sealing plug to the hole portion with just one pressing, so that it is easy to attach and the good workability is obtained.

In the invention according to the second aspect, the cylindrical body is disposed in the tilted state with respect to the center line of the hole portion.

In the invention according to the third aspect, the step portions are provided intermittently in the peripheral direction of the cylindrical body. Thus, it is possible to reduce the pressing force when the cylindrical body passes through the hole portion, so that the sealing plug is easily attached to the hole portion with a smaller force when compared with the case that the step portions are continuously provided.

In the invention according to the fourth aspect, it is possible to place the finger on the flange portion and boss. Therefore, the flange portion can be easily pressed. Also, the area where the finger is placed is increased, so that the pressing force per unit area is reduced.

While the invention has been explained with reference to the specific embodiments of the invention, the explanation is illustrative and the invention is limited only by the appended claims.

What is claimed is:

1. A sealing plug for sealing a hole portion of a panel, comprising:
a flange portion for contacting a periphery around the hole portion;
a cylindrical body extending from the flange portion to be inserted in the hole portion;
a straight portion formed on a part of an outer peripheral surface of the cylindrical body to extend parallel to an axis line of the cylindrical body;
a step portion projecting from the outer peripheral surface of the cylindrical body at a side opposite to the straight portion, said step portion abutting against the peripheral edge of the hole portion when the straight portion passes through the hole portion to allow the cylindrical body to incline with respect to a center line and holding the peripheral edge of the hole portion together with the flange portion; and
a neck portion formed between the step portion and the flange portion and having a diameter substantially same as an inner diameter of the hole portion.

2. A sealing plug according to claim 1, wherein said step portion has a lower surface inclined with respect to a surface perpendicular to the axis line of the cylindrical body, said lower surface extending from a portion away from the flange portion to a portion close to the flange portion at the straight portion.

3. A sealing plug according to claim 1, wherein said step portion includes a plurality of step members formed with a predetermined space therebetween in a peripheral direction of the cylindrical body.

4. A sealing plug according to claim 1, wherein said flange has a depression at a center portion thereof and a boss formed at a center of the depression.

5. A sealing plug according to claim 2, wherein said inclined surface extends for about a half of the cylindrical body at the side opposite to the straight portion.
